(19) United States
(12) Patent Application Publication
(10) Pub. No.: US 2010/0274165 A1
(43) Pub. Date: Oct. 28, 2010

(54) MULTI-ROLLER MASSAGE DEVICE

(76) Inventor: Charles L. Evans, Waukesha, WI (US)

Correspondence Address: Intellectual Property Dept.;Dewitt Ross & Stevens SC, 2 East Mifflin Street, Suite 600, Madison, WI, 53703-2865, US

(21) Appl. No.: 12/579,453

(22) Filed: Oct. 15, 2009

Related U.S. Application Data
(60) Provisional application No. 61/171,599, filed on Apr. 22, 2009.

(51) Int. Cl. A61H 15/00

(52) U.S. Cl. 601/122

(57) ABSTRACT

A massage device is described which alleviates pain and may be used on different parts of the body. The massage device includes a first roller and a second roller, arranged in a substantially parallel configuration. Each roller has an inner body and a soft external layer, which may include foam. A left connector bar couples the left side ends of the first and the second rollers. A right connector bar couples the right side ends of both rollers. The right connector bar is arranged in a configuration substantially parallel to the left connector bar. A third roller may be added between the first and second rollers. A user may use the multi-roller massage device to apply pressure to sensitive areas, in order to alleviate pain and discomfort.

### CROSS-REFERENCE TO RELATED APPLICATIONS

This application claims priority under 35 U.S.C. §119(e) to U.S. Provisional Patent Application No. 61/171,599 filed Apr. 22, 2009, the entirety of which is incorporated by reference herein.

### FIELD OF THE INVENTION

This document concerns an invention relating generally to a massage device, and more specifically to a roller-type massage device for alleviating pain and other symptoms primarily due to myofascial imbalances in the hips, back, shoulders, arms and legs.

### BACKGROUND OF THE INVENTION

Myofascial release is a form of soft tissue therapy intended for pain relief, increasing the range of motion, and balancing the body. The techniques used in myofascial release therapy may involve massage for stretching the fascia (i.e., soft tissue) and releasing bonds between fascia, muscles, and bones. The fascia may be manipulated to allow the connective tissue fibers to reorganize themselves in a more flexible, functional fashion.

Massage therapy has been known for a long time. Many devices have been used to implement different forms of massage therapy. For example, existing devices are operated manually or automatically to apply vibration, pressure or heat to a particular part of the human body. However, such devices tend to be expensive. In addition, some of the existing devices capable of providing these extra features, such as vibration or heat, may only be suitable for use in a particular region of the body. For example, a vibrating chair or sofa may be suitable for massaging a user's back, but may not be as effective for other areas of the body, such as the arms or thighs.

### SUMMARY OF THE INVENTION

To give the reader a basic understanding of some of the advantageous features of the massage device, following is a brief summary of preferred versions of the device, with reference made to the accompanying drawings to enhance the reader's understanding. Since this is merely a summary, it should be understood that more details regarding the preferred versions may be found in the Detailed Description set forth elsewhere in this document. The claims set forth at the end of this document then define the various versions of the massage device in which exclusive rights are secured.

The invention involves a massage device, comprising at least two rollers linked in a relatively parallel alignment by two parallel disposed connector bars. Each roller may include a cylinder having a body, a left end, and a right end. For each roller, the left and right ends may be rotatably connected to a connector bar. Thus, a left connector bar has two connecting locations. The left connector bar is attached to the left end of a first roller at a first location, while also connected to the left end of a second roller. The right connector bar attaches the right ends of both rollers in a configuration that is substantially parallel to the left connector bar. The rollers are encased or surrounded by an external layer, which preferably includes a foam cushion. Each of the two connector bars may include at least two openings, which may be used for receiving the ends of the rollers at connecting locations. It is also within the scope of the present invention for the connector bars to include at least three openings for receiving an end of at least three rollers. Further, the connector bars may include additional openings for adjusting the relative distance between the rollers.

The massage device of the present invention is effective in producing myofascial release and reducing pain. It is also suitable for massage therapy (i.e., soft tissue manipulation). The massage device allows the user to balance on and/or maneuver the adjacent rollers to establish the desired pressures for the myofascial release and the additional massage areas. For example, a user may balance his or her back on the massage device. After the user finishes treating his or her back, the user may position the massage device under the legs or between the thighs, alleviating those regions as well.

The device of the present invention can be used for efficient self-myofascial release for an experienced individual or one that is directed by a competent healthcare professional. Although the examples described and illustrated include two or three rollers, it is contemplated that the massage device may have additional rollers. The massage device may also have dimensions which differ from those described in the examples that follow. The massage device may be configured or adaptable to provide longer or shorter rollers, which may be more suitable for certain body types. Additionally or alternatively, the external layer covering the rollers may include materials other than foam. Thus, the multi-roller device of the present invention provides an economical and therapeutic way to massage the hips and back, in addition to the shoulders, arms and legs.

The objects and advantages of the invention will appear more fully from the following detailed description of the preferred embodiments of the invention made in conjunction with the accompanying drawings.

### BRIEF DESCRIPTION OF THE DRAWINGS

FIG. 1 is a top view of a first exemplary version of the invention, wherein a massage device 100 includes a first roller 102 and a second roller 104, aligned in a substantially parallel configuration. A series of pins 120, 122, 124, and 126 are used to rotatably couple the first and second rollers 102, 104 to two connector bars 106, 108.

FIG. 2 is an exploded view of the massage device 100, according to FIG. 1.

FIG. 3 is a side view of the massage device 100, according to FIG. 1.

FIG. 4 is a cross-sectional view of the massage device 100, taken along line 4-4 of FIG. 3.

FIG. 5 is a top view of a second exemplary version of the invention, wherein a massage device 500 includes a first roller 102, a second roller 104, and a third roller 502, aligned in a substantially parallel configuration. A series of pins 120, 122, 124, 126, 504, and 506 rotatably couple the three rollers 102, 104, 502 to the connector bars 106, 108.

FIG. 6 is a diagram of an exemplary therapy sequence 600, in which a user may perform any step A-F with the assistance of a massage device 100, 500 of the present invention.

### DETAILED DESCRIPTION OF PREFERRED VERSIONS OF THE INVENTION

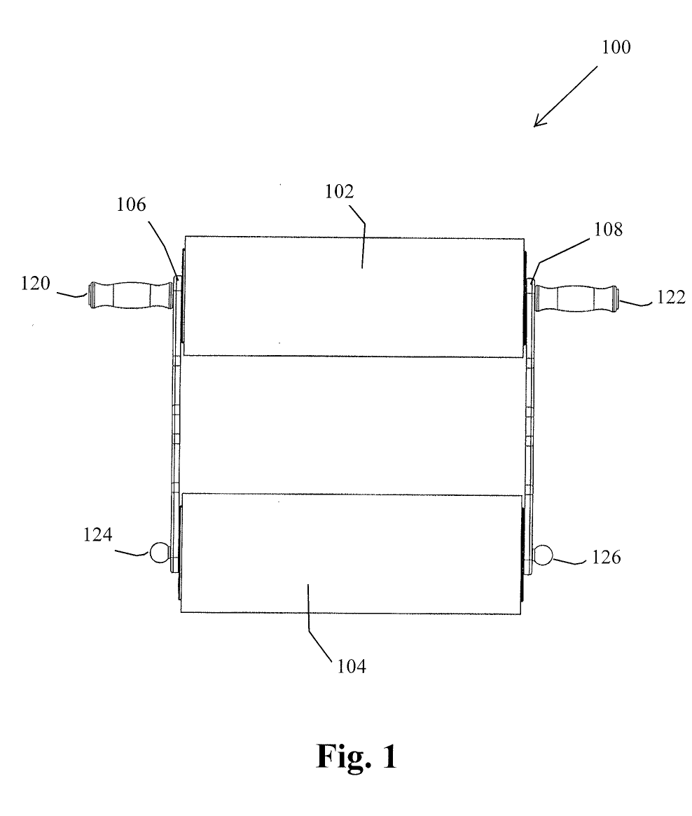

Referring to FIG. 1, the massage device 100 of the present invention may be comprised of a series of two or more foam rollers 102, 104 which may be linked together in a substantially parallel configuration by two connector bars 106, 108. As shown in the accompanying drawings, the massage device 100 may have a tandem configuration, with each connector bar 106, 108 coupling each foam roller 102, 104 at two different connecting locations.

Preferably, each foam roller 102, 104 includes a cylindrical inner body 111, 115 having end caps or hubs 112, 113, 116, 117, each of which include a centrally disposed aperture 112a, 113a, 116a, 117a. Each of the bodies 111, 115 are preferably surrounded by a soft external layer 110, 114, which may be a hygienic foam cover or foam cushion. It is within the scope of the present invention to provide the soft external layers 110, 114 with an outer covering 119, 121 generally of an elastic material, which may be easily removed for replacement or washing.

In the exemplary version shown in FIG. 4, the foam rollers 102, 104 include the cylinders 111, 115 and an external cushion layer 110, 114, which may be a foam cover. Without wishing to restrict the size, i.e., the diameter, of the cylinders 111, 115, it is within the scope of the present invention to use cylinders having a diameter between about one inch and about seven inches or larger. Preferably, the diameter of the cylinders is between three and six inches with a diameter of about four and one-inches being most preferred. The thickness of the foam cover can range from about one-half inch to five inches or more, The foam cover is preferably three-fourths of an inch thick and surrounds each tubular cylinder 111, 115, which may be made of polyvinyl chloride (PVC). Without wishing to be restricted to any specific type of foam, preferred foam for the purposes of the invention is polyethylene foam having a density of about two to about two and a half pounds. While not limited to any size or shape, a preferred size for the tubular cylinders 111, 115 is four and one half inches outside diameter. The length of each tubular cylinder 111, 115 is approximately seventeen inches. Again, the diameter and length of the cylinders 111, 115 may be adjusted as desired.

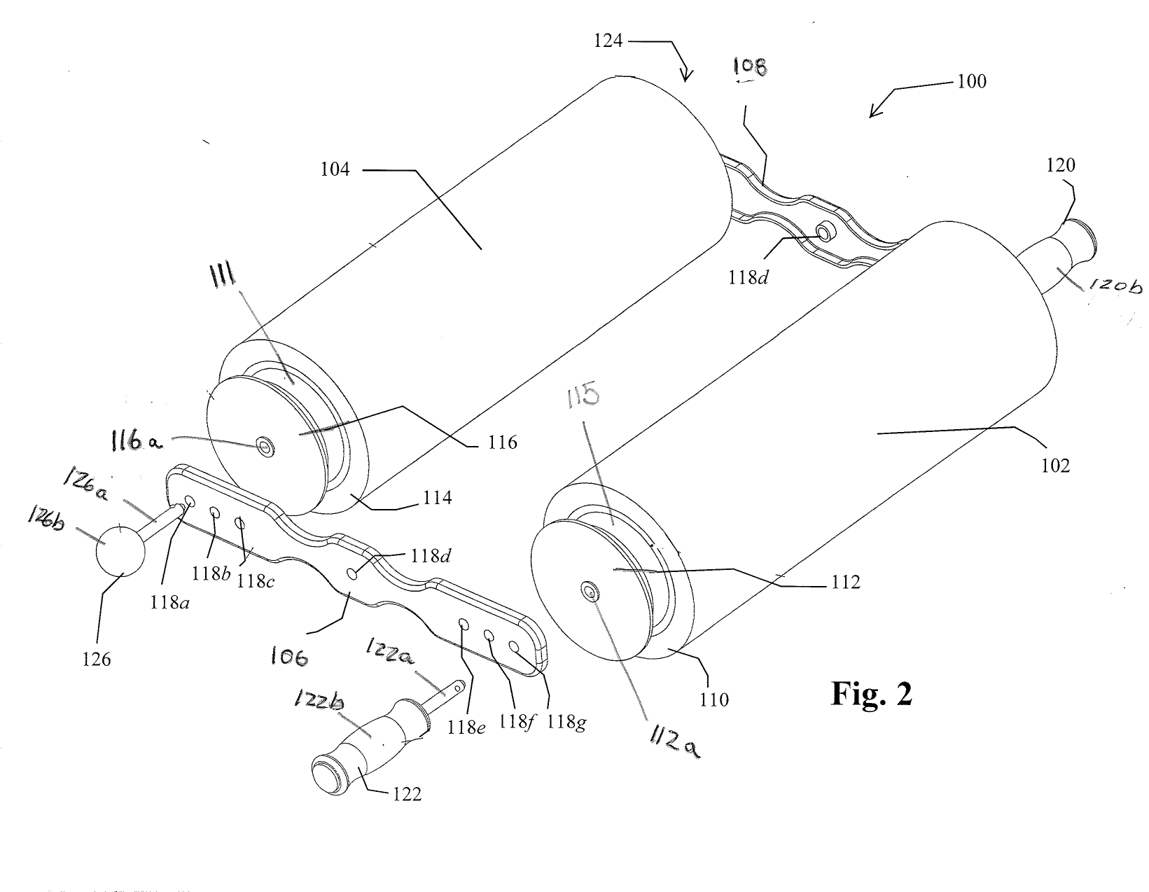

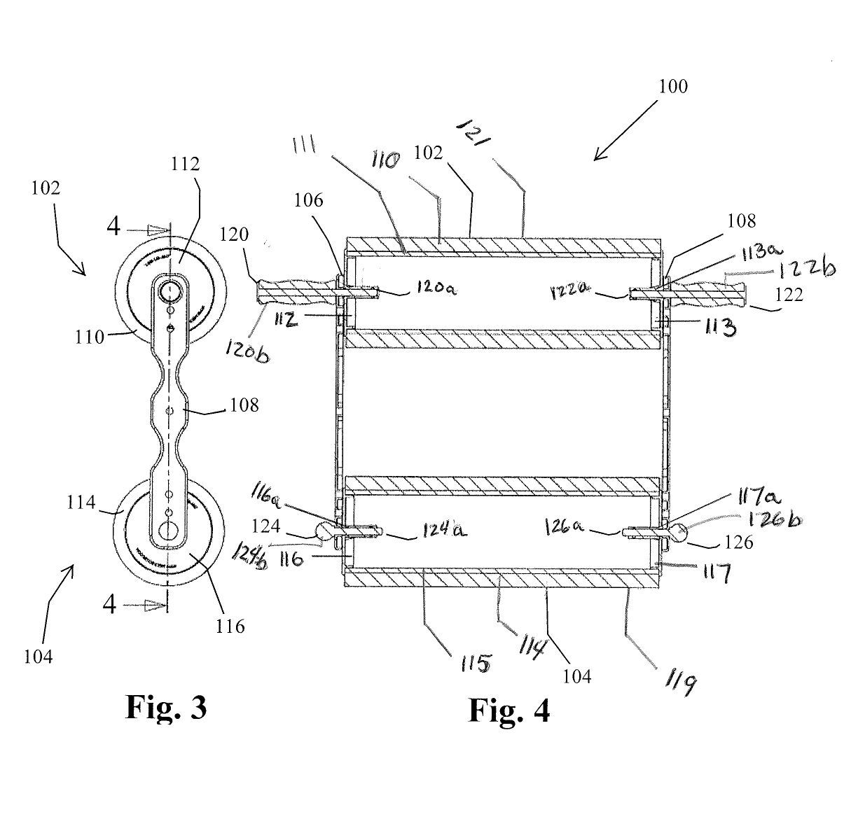

As illustrated in FIGS. 2 and 3, each connector bar 106, 108 preferably includes at least seven openings 118a-g. Also shown in FIG. 2, the openings 118a-g may be spaced apart and used to couple the end of the foam rollers 102, 104 at the position of the hubs 112, 113, 116, 117. For example, the connector bar 106 may connect the hub 112 of the roller 102 and the end 116 of the roller 104, with both rollers 102, 104 arranged in a substantially parallel configuration. Similarly, the second connector bar 108 may connect the hub 113 of the roller 102 and the hub 117 of the roller 104 using two of the seven openings (i.e., 118a, 118g).

Without wishing to be restricted to any particular size of dimension, the connector bar 106, 108 of the present invention may be approximately fifteen inches long with seven spaced openings 118a-g. The openings 118a-g are preferably located one inch, two inches, and three inches from the ends of each connector bar 106, 108. Stated another way, the openings 118a, 118b, and 118c are six and one half inches, five and one half inches, and four and one half inches from the center opening 118d of each connector bar 106, 108. The center opening 118d may be used to add a third roller.

Pins 120, 122, 124, and 126 may be used to couple the roller 102, 104 to the connector bars 106, 108. Each of the pins 120, 122, 124, and 126 may have an insertable portion 120a, 122a, 124a, and 126a and a non-insertable portion 120b, 122b, 124b, and 126b. The non-insertable portion 120b, 122b, 124b, and 126b of the pins 120, 122, 124, and 126 may have different configurations. For example, the non-insertable portion 120b, 122b of the pins 120, 122 may be elongated and used to connect both ends of a first roller 102 to the connector bars 106, 108. Preferably, the elongated pins 120, 122 connect both ends of one of the rollers (i.e., first roller 102) being used in the massage device 100. The elongated pins 120, 122, connected at each side of the roller 102 may operate as handles. Therefore, a user may grab the elongated pins 120, 122 to control the movement of the massage device 100, according to his or her preference or as recommended by a health care professional.

If handles are not desired, as illustrated by the pins 124, 126, the non-insertable portion 124b, 126b of the pins 124, 126 may be rounded, as shown in FIG. 2, or of another shape such as the end of a nail, pin or the like. These pins 124, 126 do not serve as handles and are used primarily to connect the ends of additional rollers, i.e., roller 104 in FIG. 2, to the connector bars 106, 108.

As further illustrated in FIG. 2 and FIG. 3, the pins 120, 122, 124, and 126 are inserted into apertures 112a, 113a, 116a, and 117a by means known to the art, such by pop fitting the pins into the aperture or rotatably inserting the pins by screw and thread arrangement in a manner to rotatably couple the rollers 102, 104 to the connector bars 106, 108. However, as FIG. 2 shows, the insertable portions 120a, 122a, 124a, 126a of the pins 120, 122, 124, and 126 do not extend all the way across the rollers 102, 104. After coupling or “clicking” into an aperture 112a, 113a, 116a, and 117a of a roller 102, 104, the pins 120, 122, 124, and 126 may operate as axles. It is contemplated that any attaching means and/or configuration known in the art may be used to couple the pins 120, 122, 124, and 126 to the rollers 102, 104.

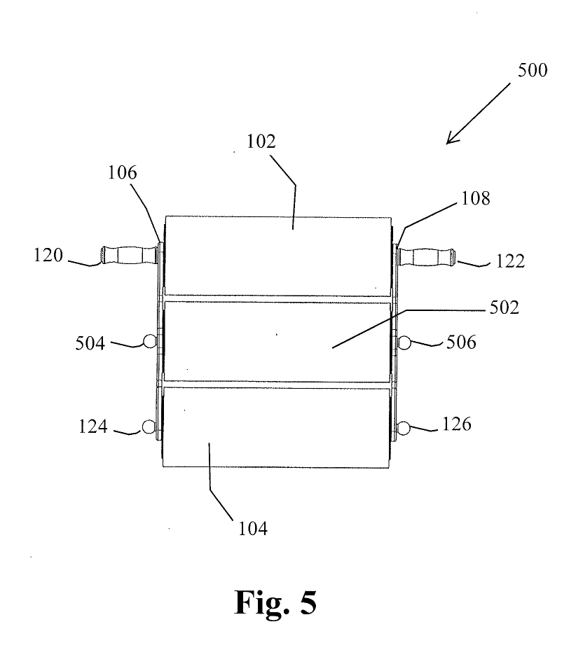

FIG. 5 illustrates a second version of the invention, including a massage device 500, having a third roller 502 coupled to the connector bars 106, 108. In an exemplary embodiment, the third roller 502 may have the same material, size, and shape as the first roller 102 and the second roller 104. That is, the third roller 502 may also have an inner body made of PVC and surrounded by an external foam layer as described with respect to rollers 102, 104. The third roller 502 may be placed between the first roller 102 and the second roller 104, with the three rollers aligned in a substantially parallel arrangement. The center opening 118d may be used to secure the roller 502 in place, with the aid of two rounded pins 504, 506.

The massage device 100, 500 may serve as a multi-roller massage device to conveniently massage and/or provide myofascial release to sore areas of the body, reducing pain. The connection of two rollers (102, 104 shown in FIG. 1) or three rollers (102, 104, and 502 shown in FIG. 5) covered in soft material such as foam, allows a person to be his or her own therapist. The massage device 100, 500 may also be used for efficient self myofascial release for an experienced individual or one that is directed by a competent health care professional.

The body part that is found to be tender, i.e., the “sore spot” or “trigger point,” may be gently rolled on. As the pain is reduced, the roller pressure may be increased. This process may require a few minutes. As the tender area is treated by increasing the pressure, the tender area pressure will become greater than the surrounding massage areas. Although not necessary for the present invention, the guidance of a physical therapist may be useful to evaluate optimal applications or positions that may benefit a particular user or health condition.

The different therapeutic capabilities of the massage device 100, 500 may be highlighted depending on the number of foam rollers that are linked together. For example, the massage device 100, (i.e., “tandem roller”) may be suitable for efficient self massage and to enhance circulation. The device 100 may also be suitable for efficient self myofascial release for experienced individuals or those individuals that may be directed by health care professionals. The massage device 500 (i.e., “tri-roller”) may provide better massage capabilities, while the “tandem roller” 100 may have better myofascial release capabilities.

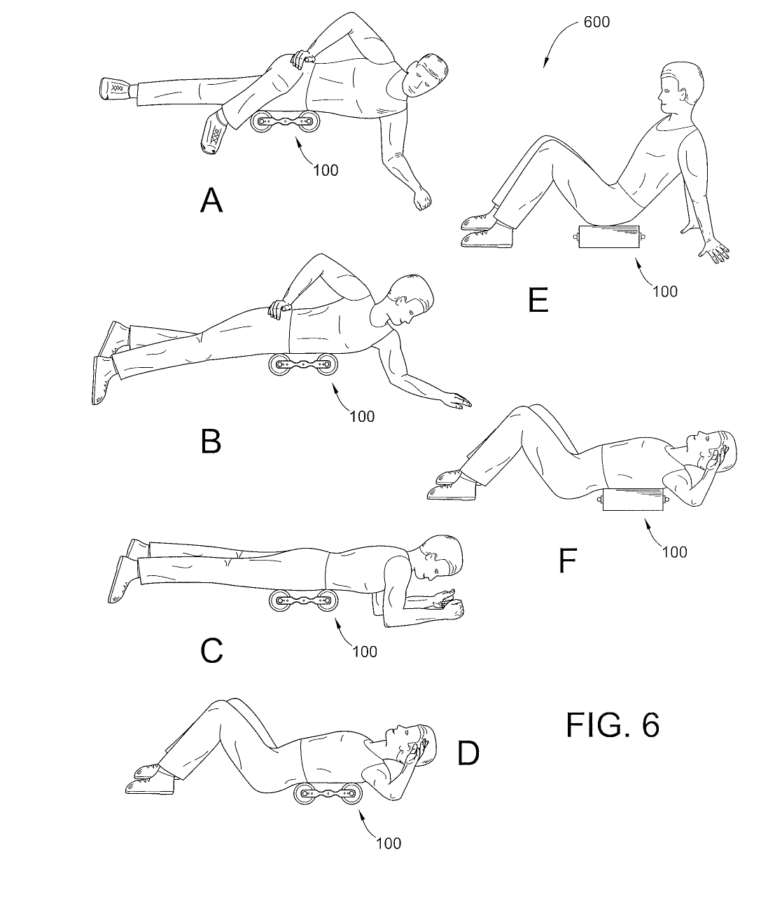

Reference is made to FIG. 6 for alternatives showing how the massage device 100, 500 of the present invention may be used. As seen in steps A-F, a person may easily use the massage device 100, 500 to apply pressure and/or to massage different parts of the body. The body part that is found to be tender, is generally rolled on and as the pain is reduced, the roller pressure is increased. FIG. 6 illustrates different steps A-F of an exemplary therapy sequence 600, which may be easily performed with the assistance of the massage device 100, 500. Therefore, although the therapy sequence 600 is shown and described with reference to the massage device 100, it is contemplated that the massage device 500 may be used alternatively or additionally, during any step of the therapy sequence 600.

As part of the exemplary sequence 600, a user may exercise a side of the body (step A), followed by the front (step B). The user may continue exercising the quad region (step C), as well as the lower and/or upper back (step D). The massage device 100 may be suitable for treating the gluteal muscles area (step E), as well as the upper hamstring. The back region (lower and/or upper) is typically a location where pain and discomfort concentrate. Thus, this region may be treated at least one more time as part of the sequence 600 (step F). In performing any of the steps A-F, the user may consider rotating the massage device 100.

Alternatively or additionally, while using the massage device 100, the body part that is found to be tender may be isolated for intensive or extended roller stimulation. When this area is no longer sensitive, the user may proceed to treat a different area. The sensitive areas that respond to the massage device 100 stimulation may be treated on a regular basis, for muscle relaxation, as well as for reducing pain or discomfort.

Many health care professionals emphasize myofascial release, stretching and strengthening exercise to achieve or maintain optimal health. Stretching and strengthening exercises are more effective when the muscles are relaxed and improve range of motion. Therefore, as yet another example, the massage device 100, 500 may be suitable for a warm-up before stretching and strengthening exercises or some related activity. The massage device 100, 500 can also be used for a cool down after exercising. As a further example, warm-up and cool-down routines may incorporate any of the steps A-F shown in FIG. 6.

In the foregoing discussion (and in the following claims), it should be understood that such terms as “first”, “second”, “third,” “left”, “right”, “perpendicular”, “parallel”, and the like are words of convenience, used to describe locations on the massage device configurations 100, 500 when oriented as shown in FIGS. 1-6. Accordingly, these terms should not be construed as limiting or excluding terms. Moreover, the massage device 100, 500 could include more than three rollers. Additional rollers may be aligned in a configuration substantially parallel to those previously added. It is also contemplated that the rollers may be linked in a vertical arrangement, with all the rollers in the massage device 100, 500 being linked to a left connector bar 106 on a left end and to a right connector bar 108 on the right end. Furthermore, the rollers may be connected side by side. In this example, a connector bar 106, 108 may be configured to couple at least two rollers at a single connecting point. As it may be appreciated from these examples, the massage device 100, 500 may be configured or adaptable to include rollers 102, 104, 502 with longer, shorter, thinner, and/or thicker cylinders 111, 115. A modified device 100, 500 may be preferable to accommodate a user of a certain age, weight, and/or height.

Preferred versions of the invention have been described above in order to illustrate how to make and use the invention. The invention is not intended to be limited to these versions, but rather is intended to be limited only by the claims set out below. Thus, the invention encompasses all different versions that fall literally or equivalently within the scope of these claims.

1. A massage device including:
a. a first roller having a left end and a right end;
b. a second roller having a left end and a right end, arranged in a configuration substantially parallel to the first roller;
c. a left connector bar, coupling the left end of the first roller and the left end of the second roller; and
d. a right connector bar, coupling the right end of the first roller and the right end of the second roller;
wherein the right connector bar is arranged in a configuration substantially parallel to the left connector bar.

2. The massage device of claim 1, wherein the left connector bar and the right connector bar are arranged in a configuration substantially perpendicular to the first roller and the second roller.

3. The massage device of claim 1, wherein the left connector bar rotatably couples the left end of the first roller with a first elongated pin.

4. The massage device of claim 3, wherein the right connector bar rotatably couples the right end of the first roller with a second elongated pin.

5. The massage device of claim 4, wherein the left connector bar rotatably couples the left end of the second roller with a first rounded pin.

6. The massage device of claim 5, wherein the right connector bar rotatably couples the right end of the second roller with a second rounded pin.

7. The massage device of claim 1, wherein each of the first roller and the second roller includes an inner body and an external layer.

8. The massage device of claim 7, wherein the inner body includes polyvinyl chloride.

9. The massage device of claim 8, wherein the external layer includes foam.

10. The massage device of claim 9, wherein the foam includes a sleeve covering the polyvinyl chloride inner body.

11. The massage device of claim 1, wherein each of the left connector bar and the right connector bar includes at least two openings for coupling an end of the first roller and the second roller.

12. The massage device of claim 1, further including a third roller having a left side end and a right side end, arranged in a configuration substantially parallel to the first roller and the second roller.

13. The massage device of claim 12, wherein each of the left connector bar and the right connector bar includes at least three openings for coupling an end of the first roller, the second roller, and a third roller.

14. The massage device of claim 13, wherein the left connector bar and the right connector bar are arranged in a configuration substantially perpendicular to the first roller, the second roller, and the third roller.

15. The massage device of claim 14, wherein the left connector bar rotatably couples the left end of the first roller with a first elongated pin.

16. The massage device of claim 15, wherein the right connector bar rotatably couples the right side end of the first roller with a second elongated pin.

17. The massage device of claim 16, wherein the left connector bar rotatably couples each of the left side end of the second roller and the left side end of the third roller with a rounded pin.

18. The massage device of claim 17, wherein the right connector bar rotatably couples each of the right side end of the second roller and the right side end of the third roller with a rounded pin.

19. The massage device of claim 18, wherein the first roller, the second roller, and the third roller each include a polyvinyl chloride inner body and a foam external layer.

20. A massage device including:
a. a first roller having a left side end and a right side end;
b. a second roller having a left side end and a right side end, arranged in a configuration substantially parallel to the first roller;
c. a third roller having a left side end and a right side end, arranged in a configuration substantially parallel to the first roller and the second roller, wherein the first roller, the second roller, and the third roller each include a polyvinyl chloride inner body and a foam external layer;
d. a left connector bar, coupling the left side end of the first roller, the left side end of the second roller, and the left side end of the third roller; and
e. a right connector bar, coupling the right side end of the first roller, the right side end of the second roller, and the right side end of the third roller; wherein the right connector bar is arranged in a configuration substantially parallel to the left connector bar, and substantially perpendicular to the first roller, the second roller, and the third roller;
f. a first elongated pin for rotatably coupling the left connector bar to the left side end of the first roller;
g. a second elongated pin for rotatably coupling the right connector bar to the right side end of the first roller; and
h. at least four elongated pins for rotatably coupling the left connector bar to the left side end of the second roller and the third roller, and for rotatably coupling the right connector bar to the right side end of the second roller and the third roller.
